(19) United States
(12) Patent Application Publication
(10) Pub. No.: US 2014/0025552 A1
(43) Pub. Date: Jan. 23, 2014

(54) SYSTEM AND METHOD FOR MANAGING CREDIT DEFAULT SWAPS

(71) Applicant: trueEX Group LLC, New York, NY (US)

(72) Inventors: Sunil Hirani, Greenwich, CT (US); James Miller, New York, NY (US)

(73) Assignee: trueEX Group LLC, New York, NY (US)

(21) Appl. No.: 13/947,696

(22) Filed: Jul. 22, 2013

Related U.S. Application Data
(60) Provisional application No. 61/674,155, filed on Jul. 20, 2012.
(60) Provisional application No. 61/684,465, filed on Aug. 17, 2012.
(60) Provisional application No. 61/728,960, filed on Nov. 21, 2012.
(60) Provisional application No. 61/825,432, filed on May 20, 2013.

(51) Int. Cl. G06Q 40/04

(52) U.S. Cl. CPC G06Q 40/04
USPC 705/37

(57) ABSTRACT

The present invention is a system and method for providing improved functionality for management of credit futures products. The improved system includes functionality implementing trading capabilities for trading credit default swaps, including providing a user with relevant market information for assessing and placing offers for credit default swaps, as well as for managing offers already placed.

### PRIORITY INFORMATION

The present application is a utility application, and claims priority to United States Provisional Application Serial No. 61/674,155, filed Jul. 20, 2012, titled Trading Platform for Futures Products, in the names of Sunil Hirani and James Miller, Ser. No. 61/684,465, filed on Aug. 17, 2012, titled Trading Platform for Futures Products, in the names of Sunil Hirani and James Miller, Ser. No. 61/669,887, filed on Jul. 10, 2012, titled Margin Optimizer Concept, in the names of Sunil Hirani and James Miller, Ser. No. 61/687,088, filed on Apr. 17, 2012, titled Unwinds Concept, in the names of Sunil Hirani and James Miller, Ser. No. 13/864,988, filed on Apr. 17, 2013, titled System And Method For Managing Derivative Instruments, in the names of Sunil Hirani and James Miller, Ser. No. PCT/US13/36987, filed on Apr. 17, 2013, titled System And Method For Managing Derivative Instruments, in the names of Sunil Hirani and James Miller, Ser. No. 61/728,960, filed on Nov. 21, 2012, titled Margin Optimizers, in the names of Sunil Hirani, James Miller and Alex Francisci, and Ser. No. 61/825,432, filed on May 20, 2013, titled FCM Capital Optimization Strategy (COS™), in the names of Sunil Hirani and Arthur Korsun; and System and Method for Managing Derivative Instruments, Patent Application Ser. No. 13/938,879, filed on Jul. 10, 2013 the contents of each of which are incorporated herein in their entireties by reference thereto.

### BACKGROUND

The present invention relates to the incorporation of credit futures product handling into a derivatives trading platform, such as that disclosed in applicant's previously filed platform patent applications identified in the priority section of this application.

Definitions and Acronyms

Aggress—users can trade CDS's by clicking on the top of the book price and hitting/lifting the price or by entering a Contra Order.

Auction Final Price—in relation to an index name that has suffered a credit event, the final price (expressed as a percentage) determined in the course of a credit event auction

Auction Final Price Determination Date—the day on which an auction final price is determined and published

Bid—the price at which a user buys a CDS

Cancel—cancel a user's order for a CDS

Central Limit Order Book (“CLOB”)13 the trading model supported by the trueEX Platform for trading trueEX Futures. The CLOB provides a mechanism for the automatic matching of CDS's on a “price time priority” basis. The highest bid order and the lowest offer order constitutes the best market or the “touch” in a given CDS contract. The platform central limit order book may provide continuous automatic matching throughout the trading day

Close—close the current window of the platform UI

Contra Order—an order that is on the opposite side of an existing CDS order. Contra orders are created when countering or aggressing an existing order

Credit Derivatives Determinations Committee—a committee established for the purpose of making determinations (including the occurrence of a credit event) in connection with credit derivative transactions

Credit Events—as defined in the ISDA Credit Derivatives Definitions (as amended and supplemented from time to time)

Credit Event Auction—an auction administered pursuant to credit event derivatives auction settlement terms

Exchange Trading—The purpose of a futures exchange is to act as an intermediary and minimize the risk of default by either party. Thus, the exchange requires both parties to put up an initial amount of cash (i.e., margin). Additionally, since the futures price will generally change daily, the difference in the prior agreed-upon price and the daily futures price is also settled daily. The exchange will draw money out of one party's margin account and put it into the other's so that each party has the appropriate daily loss or profit. If the margin account goes below a certain value, then a margin call is made and the account owner must replenish the margin account. This process is known as marking to market

FIX Gateway—a financial information exchange gateway to allow users to access the platform via the API.

Futures—A future is a standardized contract between two parties to exchange a specified asset of a standardized quantity and quality for a price agreed today (typically the strike price) with delivery occurring at a specified future date (the delivery date). Unlike OTC contracts, futures contracts are traded on a regulated futures exchange. The party agreeing to buy the underlying asset in the future, the “buyer” of the contract, is said to be “long”, and the party agreeing to sell the asset in the future, the “seller” of the contract, is said to be short”. In many cases, the underlying asset to a futures contract may not be a traditional commodity and may include interest rates or credit derivatives. Like OTC derivative contracts, a futures contract can either be cash or physically settled

IG Index or Index—a North American Investment Grade Swap Index (or any other index to be specified by trueEX)

ISDA—the International Swaps and Derivatives Association

Limit Orders—orders to buy and sell a stated quantity of CDS's at a specified price, or at a better price

Markit CME Settlement Price—in relation to the IG Index (and each contract index series), the daily settlement price calculated by the CME for “over-the-counter” swaps on such series which are cleared by it. These settlement prices are used for calculating daily mark-to-market valuations and are published daily on the CME web page

Notional—the notional amount of a derivatives contract

Offer—the price at which a user sells a derivatives product

Order—Either a Bid or an Offer. All orders on the platform are Limit Orders that are good until canceled (or expired) at the end of the trading day

Platform—the full electronic exchange platform, including the UI and the FIX Gateway. The UI and FIX Gateway operate in tandem to allow the trading of CDS's

Post—to place a derivatives product order (also used to join an existing price that already has an order)

Price—the level at which the user wishes to trade derivatives product

Trade Induced Transaction—an anonymous work-up facility provided on the platform that allows users to aggress a CDS order and then increase the size of that CDS transaction without disclosing the size to the market prior to the trade occurring

UI—User Interface

The primary purpose of credit derivatives is to enable the efficient transfer and repackaging of credit risk. Credit default swaps (“CDS's”) have enabled banks to diversify their exposure and increase their lending capacity. They have quickly become the most efficient and liquid instruments for lenders, bond investors, traders and portfolio managers to effectively transfer and manage credit risk. Over the years, the credit derivatives market has become more of a trading market. CDS's have been viewed as a proxy for trades in actual loans or bonds of the relevant reference entity. Accordingly, credit derivatives trades have become easy tools to replicate a funded cash bond or cash loan of a reference entity, minus all the inflexibilities, lack of availability or regulatory and geographical barriers associated with it.

Historically, the participation of banks has accounted for the majority of the markets outstanding notional. Accordingly, the regulatory treatment of banks/credit derivatives, and the implementation of stricter capital adequacy requirements will impact the shape of the market going forward.

CDS's are bi-lateral contracts between two parties, in which the buyer of protection agrees to pay a premium to the seller of protection over a set period of time (the most common period being five years). In return, the seller of protection agrees to pay the buyer the “loss amount” following a credit event in relation to the reference entity. The “loss amount” is typically determined by way of reference to a bond or loan of the entity referenced in the CDS. The most common credit events are bankruptcy, failure to pay and restructuring. Over-the-counter CDS's are typically unfunded (i.e. the protection seller is not required to put down any money upfront, save for initial margin).

Given that a CDS is a derivative instrument, it does not require either of the parties to actually hold the reference asset (i.e. bond or loan). Thus, a bank may buy protection for an exposure it has, or does not have, or irrespective of the amount or term for which it has actual exposure. Accordingly, the amount of compensation that can be claimed under a CDS is not related to the actual losses suffered by the protection buyer.

Following the occurrence of a credit event, a CDS contract can either be settled physically or by the payment of cash. Cash settlement means a reference asset of the reference entity will be valued, and the difference between its par and recovery value will be paid by the protection seller. Physical settlement means the protection seller will acquire a defaulted reference asset, for the payment of par. Today, the majority of CDS contracts are cash settled using the standardized ISDA credit event auction mechanism.

A credit index is effectively a basket of CDS's traded as a single instrument. A credit index is a quick and efficient way for users to gain access to corporates in a specific region or sectors. Liquidity, transparency and low trading costs have all been important factors in driving the growth in credit indices. Examples of credit indexes are the equally weighted Markit iTaxx/CDX indices, which began trading in 2004 and which are broadly regarded as a proxy for the corporate credit markets in the relevant regions. Like a single name CDS, the buyer of protection pays a quarterly coupon in return for a cash settlement payment following a credit event in relation to any one of the underlying constituents of the credit index. The Markit iTraxx/CDX credit indices “roll” each March and September (i.e. a new series of the index is launched with new constituents and a different maturity date).

A future is a standardized contract between two parties to exchange a specified asset of a standardized quantity and quality for a price agreed today (typically the strike price) with delivery occurring at a specified future date (the delivery date). Unlike OTC contracts, futures contracts are traded on a regulated futures exchange. The party agreeing to buy the underlying asset in the future, the “buyer” of the contract, is said to be “long”, and the party agreeing to sell the asset in the future, the “seller” of the contract, is said to be “short”. In many cases, the underlying asset to a futures contract may not be a traditional commodity and may include interest rates or credit derivatives. Like OTC derivative contracts, a futures contract can either be cash or physically settled. From a regulatory capital perspective, banks may be required to hold more capital against OTC derivative contracts versus commodity based futures contracts.

One example of a CDS contract, herein referred to as a Credit Index Futures Product (“CIFP”), may be a CDS linked to a North American Investment Grade Index Swap (“IG Index” or “Index”) or any other index specified by an establisher of the futures contract. The CIFP, as shown in FIG. 1, may reference a specific series of the Index which is published and which may commence trading seven (7) months (or such other period of time to be specified by the establisher of the futures contract) prior to the expiry of the relevant contract (each a “contract index series”). The constituents of a contract index series are typically published a few days prior to the date on which it first starts trading, on or about the 20^{th} day of March or September. The Index is composed of a designated number of equally-weighted investment grade companies domiciled in North America. Each contract index series initially may have a 5.25 year maturity, and trade as a credit default swap that exchanges quarterly fixed rate payments of a specified coupon rate (“coupon”) for floating rate payments based upon the occurrences of credit events (such as determined by ISDA Credit Derivatives Determination Committee) with respect to companies referenced in the contract index series.

Settlement: In relation to each CIFP, delivery may occur as follows:

(a) In the case of physical delivery: For a regular contract, the relevant contract index series with a notional amount equal to the unit of trading, and

(b) In the case of cash delivery: For a regular contract and a mini contract, the final cash settlement price of the unit of trading on the last day of trading (as described below).

Trading: Trading in CIFP's may be regularly conducted in the first contract in the October-April semiannual cycle referring to the contract index series issued in the prior March-September cycle. One contract per contract index series may be open for trading. For a period of approximately 1 month, one contract each for two consecutive contract index series will trade at the same time to permit rollover from one contract index series to the next (as shown in Appendix 1).

There may be two units of trading, namely:

(i) Regular Contract—which shall be $10,000,000 (or such other value as may be specified by the establisher of the derivation contract);

(ii) Mini Contract—which shall be $250,000 (or such other value as may be specified by the establisher of the derivation contract).

The price of each derivatives contract may be quoted in points. Using the example values provided in (i) and (ii) above, one point equals $100,000 for the regular contract and $2,500 for the mini contract. Par may be on the basis of 100 points. The minimum price fluctuation may be 0.001 of one point ($100) for a regular contract and 0.005 of a point ($12.50) for a mini contract. Contracts may not be allowed to trade on any other price basis. (The values specified in this paragraph are subject to change if the values assigned by establisher of the derivatives contract to the regular contract and mini contract are modified.)

Initial margin may be determined in accordance with the standard margining methodology for the relevant clearing house.

Credit Events: In relation to any credit event, such as shown in FIG. 2, for which an auction final price determination date has occurred during the term of the CIFP, such settled credit event shall be accounted for in the CIFP at the auction final price as determined by the credit event auction process for the relevant name. Cash flows that are payable as a result of any credit event settlement shall be paid as prescribed in such credit event auction process, and the unit of trade will be adjusted for the reduction of notional in the index.

Pricing of the CIFP Following a Credit Event: Assuming an index with a fixed rate coupon of 1% (and current DV01 of 4.9) 100 days after the roll, with name ABC that had a credit event and the related auction final price is 35%. The index may have only 124 names remaining. Assume also (as is current) short-term interest rates close to zero, which makes discounting negligible. Then, theoretical pricing for the derivatives Contract would be the aggregate of:

(1) the clean price of IG Index (expressed in basis points),

Assuming the index is trading at 105, the discounted (with short term rates close to zero) clean price would then be approximately 99.755 which is (100 par—0.245 of spread widening {5/100*4.9}).

(2) plus/minus financing charge difference, and

Assuming initial margin of the index and CIPF are similar, this is approximately 0 currently.

(3) minus fixed rate of the index anticipated to be received until expiry.

Assuming 214 days during the term of the derivatives Contract, 114 days of anticipated coupon discounted at risky rate (and compounded since index cash flows are paid quarterly) which would be about 0.315 basis points {100 bps/100*114/360, discounted at 105 current index trading price, compounded for quarterly payments.} After a credit event but before the related credit event auction, fixed rate would not be anticipated with respect to the credit event name.

The theoretical price of a CIFP would therefore be, after rounding to the appropriate price increment, 98.644{(99.755-0.315)*124/125}

Pricing Spread: The difference between the price of the IG Index and the CIFP is known as the “spread”. Given that the theoretical price of the CIFP includes a reduction of the clean price of the IG Index by the amount of fixed rate payments anticipated to be received during the period from the trade date through to expiry, the CIFP will typically trade at a discount to the price of the IG Index.

Expiry: The last trading day of any CIFP may be the first business day seven (7) months (or such other period as may be specified by the establisher of the derivatives contract) after the issuance of the contract index series. After trading in expiring contracts has ceased, any expiring Contracts that remain open may either be physically settled or liquidated by cash settlement (as described below).

Delivery on CIFP's for Cash Settlement: Delivery against CIFP's for cash settlement may be through the relevant clearing house, following normal variation margin procedures. The final settlement price may be calculated on the last day of trading based on the Markit CME Settlement Price (or such other market settlement price to be specified by establisher of the derivatives contract).

Delivery on CIFP's for Physical Settlement: To the extent that physical delivery has been specified at least [3] business days prior to expiry of the Contract, physical delivery may be a swap on the relevant contract index series with an unadjusted notional amount equal to the unit of trading.

Block Minimum: The CIFP may be eligible for block trading at a minimum amount to be specified by the establisher of the derivatives contract.

### SUMMARY OF THE INVENTION

The purpose of the present invention is to provide a transparent and regulated exchange allowing users to trade a number of derivative products, including CDS's and CIFP's . The invention is implemented in an electronic platform which allows users to trade derivatives products through three mechanisms: posting bids/offers for derivatives products on the platform, executing on executable bids/offers for derivatives products on the platform via the mechanism of a Central Limit Order Book, and participating in trade-induced sessions for derivatives products on the platform. Efficient trading of such products is enabled through the features and functionality of the platform, as discussed further below. Completion of trades is implemented through integral processing of clearing the trades through the relevant clearing house, thus providing transparency to the process.

In one embodiment, the present invention may be implemented in a computer implemented derivative management system having a market tracking module for identifying offers and bids associated with credit default swaps, and instructions for displaying for a user a list of potential credit default swaps such that said user can identify potential pricing for an order for one or more of said credit default swaps, and implement said order through selection of offered actions displayed on said display.

In an alternate embodiment, the present invention may be implemented in a computer assisted process which determines current prices associated with offers and/or bids for credit default swaps and displays said information for a user, such that said user may generate an order for a credit default swap wherein said order complies with price controls associated with said order or with said credit default swap.

### BRIEF DESCRIPTION OF THE FIGURES

FIG. 1 illustrates characteristics of trading for a credit index futures product.

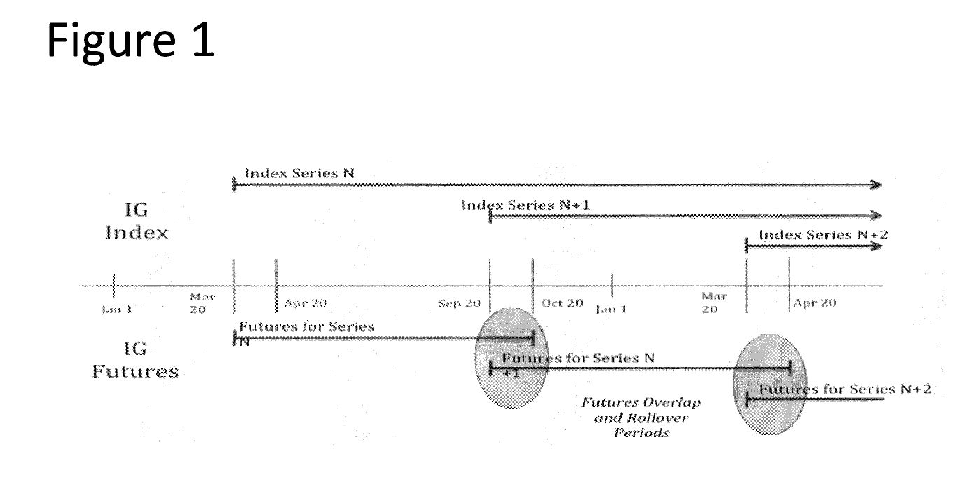

FIG. 2 illustrates characteristics of a credit event associated with a credit index futures product.

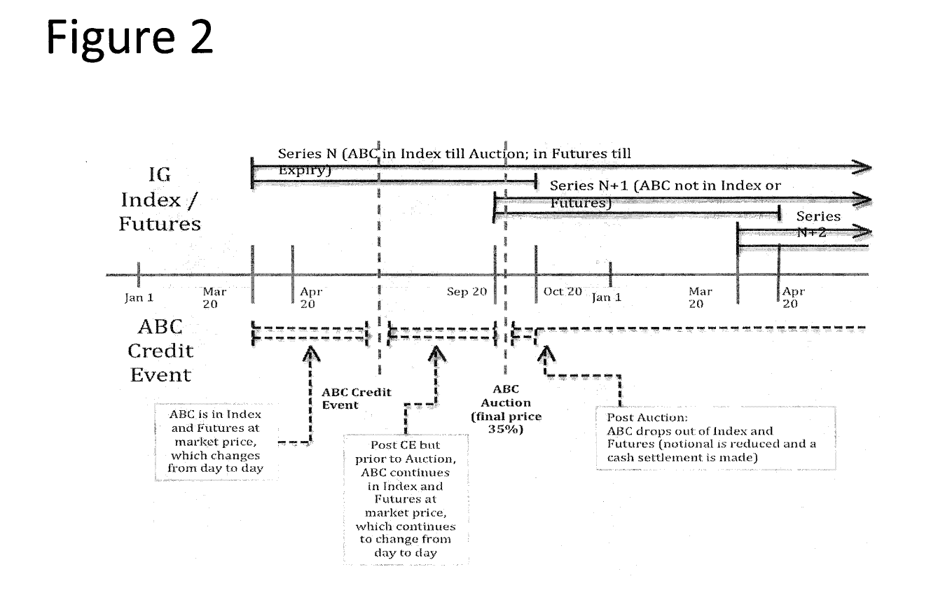

FIG. 3 illustrates a notional user interface (UI) illustrating a Market View to allow trading of credit index futures products on a derivative instruments management platform.

FIG. 4 illustrates a notional user interface (UI) illustrating a Market View to allow trading of credit index futures products on a derivative instruments management platform utilizing an incremental presentation of data.

FIG. 5 illustrates a simplified process for implementing trading of credit default swaps on a derivative instruments management platform.

FIG. 6 illustrates an order status page user interface to allow trading of credit index futures products on a derivative instruments management platform.

### DETAILED DESCRIPTION OF THE INVENTION

Liquidity in the OTC credit derivative market is heavily concentrated in the hands of a limited number of participants and this will have an adverse impact on the growth of this market going forward. In addition to this, dealers have been aggressively cutting their balance sheets and they will be subject to increased capital constraints under proposed regulations. A viable and broadly accepted credit futures contract will draw new participants into this market and will also be economically more efficient from a capital and margin perspective.

The present platform enables the electronic execution of futures product exchanges via the mechanics of a Central Limit Order Book. Multiple users have the ability to post Limit Orders during the course of the trading day. These orders for future products are prioritized in the order book stack on the basis of price and time priority (i.e. the best price order always has the highest priority). Orders may be valid once they are submitted through the UI and will be subject to specific price and notional validations.

The Futures UI and platform are partially based on a “matching model” and partially on an “aggressor model.” In the case of the latter, a user must take action to initiate a futures product trade. A user may select an order at the top-of-the-book to aggress, which creates an order in the platform. If the order matches (as expected), it is filled and a futures product trade is generated at the appropriate price. If not, by default, the platform will put the order in the appropriate place in the order stack (likely top of the book).

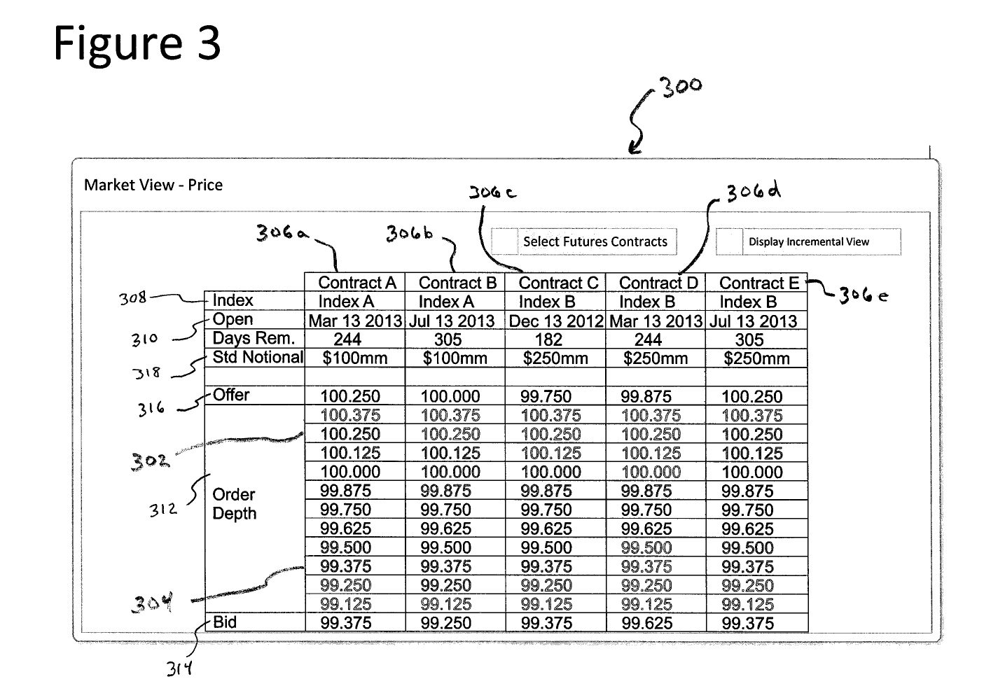

As shown in the Figures, in which like numerals are used to identify like elements, there are shown aspects of the present invention. In FIG. 3, there is shown a user interface (“UI”) 300 for allowing a user of the platform to implement trades in CDS's. The platform UI “Market View” for futures products may display both the top of the book 302 and depth of the market 304 to provide ready reference to the state of the market. Different platform futures contracts 306a, 306 b . . . may preferably be displayed in a left to right manner according to the underlying index 308 and maturity 310 of the contract. Order depth 312 may be displayed in real time across the platform futures contracts so that market activity may be presented in a readily interpretable manner. Bids 314 may be displayed on the bottom of the price window, with offers 316 on the top of the price window. Standard notional amounts 318 for each products contract may be displayed next to the description of the contract.

The platform Futures UI may additionally, for example, display a user's orders indicated by a specific color, such as orange, such that the user's orders, and their position in the order stack, are readily identifiable to the user. The order display may be further coded, for example, to indicate whether the order is the top order, but not the best order, in which case the price may be shown, for example, as normal in blue, with an orange corner in the top right. As another example, if the user is best, but another user has posted the same price, the indication may be reversed—the price may be shown in orange with a blue corner in the top left. Alternately, shading may be used to indicate order depth, as shown in FIG. 3.

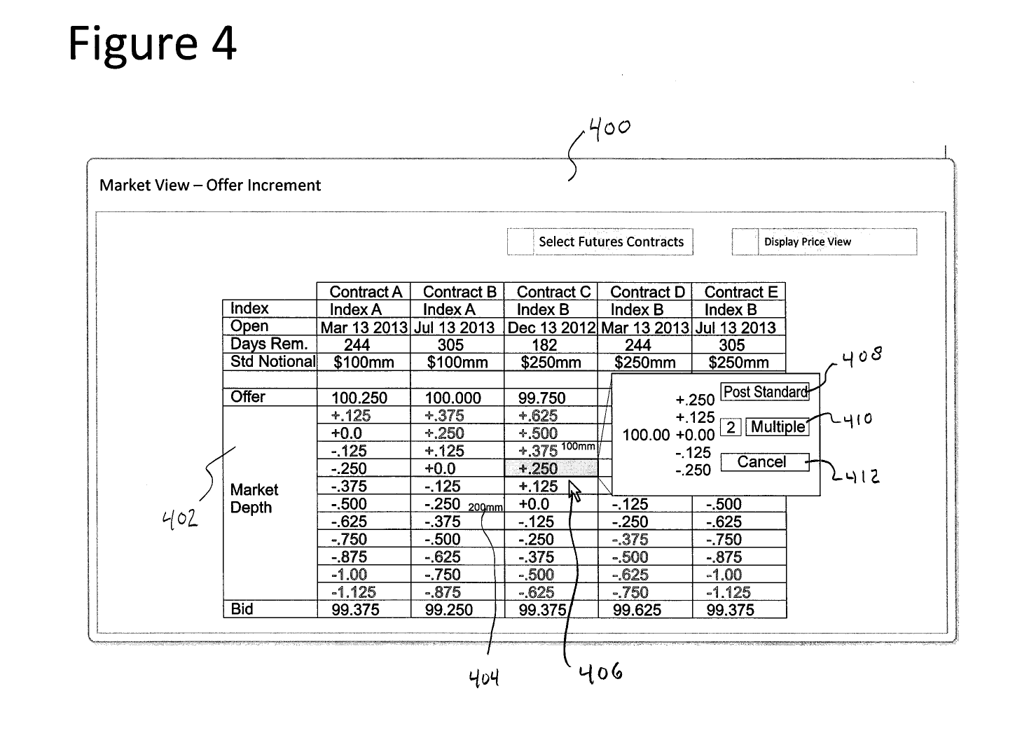

As shown in FIG. 4, Market Depth 402 may be displayed for each derivatives product contract by having each depth point shown as a specific price increment 409 from the best (bid/offer) and indicating 404 where orders are not for a standard notional (with their notional indicated on the price point).

As shown in FIG. 4, users may place orders for derivatives products directly on the platform UI at either the top of the book or at a price point in the depth. The interface may allow users to place an order by moving a pointer, such as a mouse cursor 406, over the desired price level. The UI may provide several options, depending on if the user is over the top of the book or a depth bar. By hovering over the depth bar, the user will have the option to post a standard 408 or custom notional 410. Clicking on “Cancel” 412 may be used to close the window.

If the user wants to post at the top of the book, the user may place a pointer over the price—in this case, the top of the book. If the user selects Post, they may be given standard notional options plus a custom notional option. The user may also click on the price and override it.

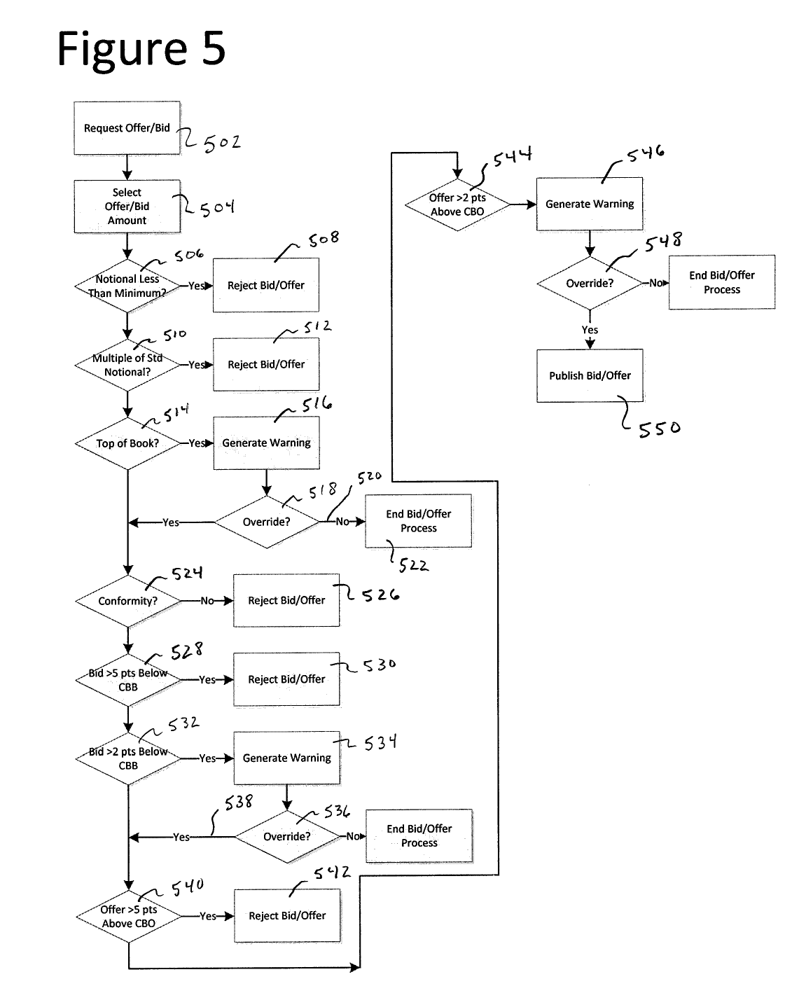

The process for such transactions is shown in FIG. 5. A user may indicate a desire 502 to place an order on the UI, and select 504 an offer or bid amount. The platform may then test the offer/bid, to preclude invalid orders from being placed. The order may first be tested to determine whether the order includes a notional less than a minimum size 506. If the order does contain a notional amount less than the minimum, the order may be rejected 508. The order may then be tested 510 to determine if whether the notional is a multiple of the defined lot size, If the order is not for a multiple of the defined lot size, the order may be rejected 512.

In addition, futures products may have price controls imposed on the orders. To that end, an order may be tested to determine whether price control warnings are indicated, or whether an order should be rejected. An offer may be tested 514 to determine if the offer is above the top of the book of offers. A user attempting to post an offer better than the best offer, or a bid lower than the best bid may receive a warning 516. Should the user desire to override 518 the warning, the user may so indicate, at which point further price control testing can continue. If the user does not desire 520 to override the warning, the offer may be rejected 522, and the process may end. The order may next be tested 524 for offer conformity with offer requirements, such as whether the offer increment is within standard increments, such as whether the increment uses more or less than four decimal places. If the order does not conform, the offer/bid may be rejected 526. Next, may be tested 528 to determine whether the bid has a bid price lower than the current best bid. If the offer has a bid price more than five basis points below the current best bid price, the bid may be rejected 530. If the bid has a bid price lower than two basis points below the current best bid 532, the platform may generate 534 a warning to the user. Should the user desire to override 536 the warning, the user may so indicate 538, at which point further price control testing can continue. If the offer has an offer price more than 5 basis points above the current best offer 540, the offer may be rejected 542. If the offer has an offer price more than two basis points above the current best offer 544, the platform may generate 546 a warning to the user. Should the user desire to override 548 the warning, the user may so indicate, at which point the bid or offer can be published 550.

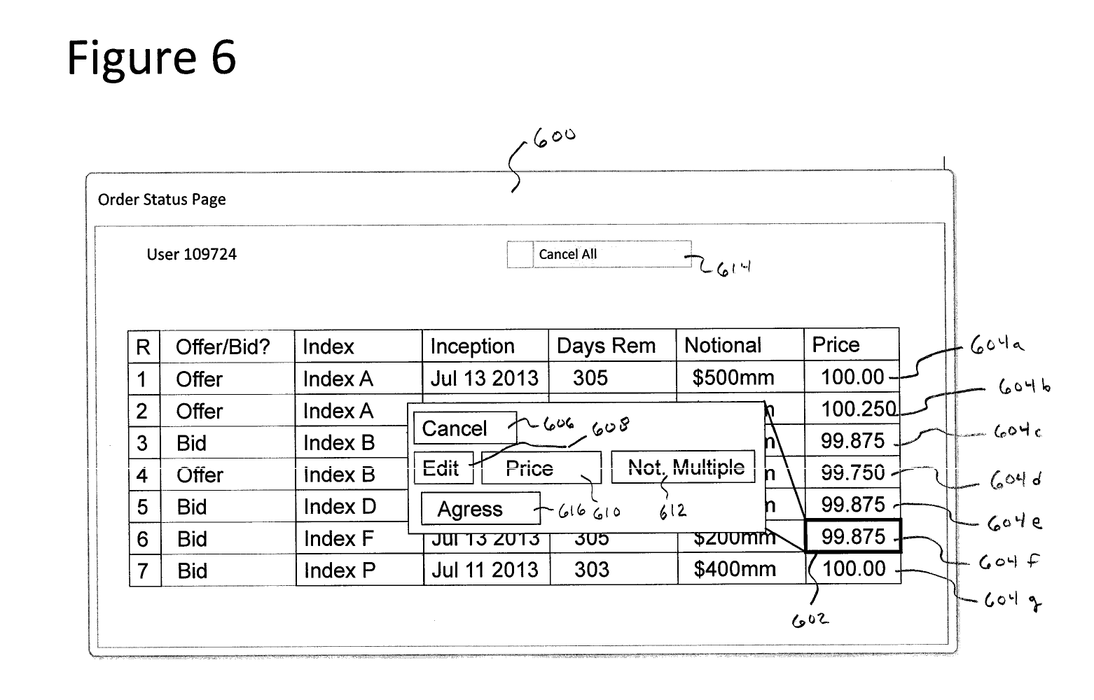

Additionally, once an order has been placed, a user may desire to cancel or edit the order. As shown in FIG. 6, the UI may provide a offer status page 600, displaying a selection allowing a user to cancel or edit an existing order. Users may cancel any of their own futures products orders by moving a pointer 602 over the price level 604a, 604b . . . at which their order resides. When they do so, the platform UI may provide the option to Cancel 606 or Edit 608 the order. There may be no confirmation required when Cancel is selected. When Edit 608 is selected, the platform UI may show the same view as “Post”—with the notional and price defaulted to the current levels for the user's futures products order. The user may change price, notional, or both.

Users may also cancel all of their orders by select the “Cancel All” 614 option at the top. Cancel All preferably requires confirmation.

A request to Cancel (or Cancel All) entered at the UI may be treated as only a request until implemented through a central processor, such that if a contra order which matches the order at the matching engine prior to the Cancel request being received, the platform may still create a trade in accordance with a trading protocol.

Users may aggress 616 an order to create a derivatives product trade. On the platform UI, aggressing an order causes a contra order to be created at the same price as the existing order. If an order at the contra order price (or better) is resting on the order book when the user's contra order reaches the matching engine, the platform may match the contra order at the best price possible.

To attempt to aggress a derivatives product order, the user may move a pointer over the top of a book price and be given the option to Pay (if aggressing an offer) or Receive (if aggressing a bid). The platform UI may default the size of the contra order to the standard size of the product. Preferably only the top of the book price may be aggressed.

The platform UI may require confirmation of the intent to aggress an order. The user may change the size to either a default size or a custom size (in the same manner as posting an order).

The platform UI may be designed to make the confirmation easy on the user—for example the buttons for the initial action and the confirmation may be in the same location so that a user can quickly click twice to initiate the action.

If the top of the book price changes while the aggress order window is displayed, there may be two options for the user:

1. If the price improves, the user may not be notified (to reduce latency) but the user's order can be filled at the better price if it remains executable when the Contra Order reaches the Order Book.

2. If the price gets worse, the user is may be warned and the option to Pay or Receive may be disabled.

Trade Induced Transaction for Futures Products. As previously discussed, if a new futures product order touches or crosses the highest priority existing order in the order book that is on the contra side, the platform may generate a trade and create a resulting Trade Induced Transaction session. Trade Induced Transaction sessions for derivatives products may result in the creation of Trade Induced Transaction specific order books that are available only during the session. Users may place specific orders intended for the Trade Induced Transaction order book.

If a Trade Induced Transaction session is initiated as a result of a derivatives product trade, any unfilled portion of the orders in the trade may automatically be moved to the Trade Induced Transaction order book (and the original participants in the trade may always have top priority). Orders in the initial Trade Induced Transaction session may be matched at the end of the session based on the priority of the order.

Existing normal platform orders at the traded level may be entered into the Trade Induced Transaction order book by default (in their current priority as the Trade Induced Transaction order book). The user may cancel the order at any point during the Trade Induced Transaction session as long as the order is not matched.

Trade Induced Transactions sessions may be terminated in one of the following ways:

1. Automatically terminating the continuing session if the continuing session has had no trades for a defined-duration of the continuing session (for example, 10 seconds); or

2. Automatically terminating the continuing session if at the end of an initial session or at any time during a continuing session, if there are no active orders for the Trade Induced Transaction session.

Following the Trade Induced Transaction session, if any futures product trades are executed, the platform may process the trades in the same manner as regular trades executed via the normal order book. Unexecuted derivatives product orders may be moved back to the normal order book at the end of the Trade Induced Transaction session, with priority based on initial time that the order was sent to the platform.

The present invention may be embodied in other specific forms without departing from the spirit or essential attributes of the invention. Accordingly, reference should be made to the appended claims, rather than the foregoing specification, as indicating the scope of the invention.

What is claimed is:

1) A computer-implemented derivative instrument management system comprising:
a computer platform having: an interfaces that elicits and receives information from users of the system; a market tracking module which tracks bids and offers for credit default swaps, an interface that allows communications with a clearing house for requesting clearing of executed trades of credit default swaps; a database for storing information associated with a user's portfolio; and instructions for displaying for a user current bid and offer information for credit default swaps and receiving from said user instructions to make an offer for a credit default swaps.

2) A computer-implemented derivative instrument management system according to claim 1, wherein said credit default swaps is a credit index financial product.

3) A computer-implemented derivative instrument management system according to claim 1, wherein said current bid and offer information is displayed as current product price.

4) A computer-implemented derivative instrument management system according to claim 1, wherein said current bid and offer information is displayed as an incremental difference from current product price.

5) A computer-implemented derivative instrument management system according to claim 2, wherein said instructions for displaying for a user current bid and offer information further generate a display identifying order options when a user places a position indicator over a price on said display.

6) A computer-implemented derivative instrument management system according to claim 5, wherein said display identifying order options comprises a selectable item which when selected generates a bid to purchase a selected credit default swap at a selected price.

7) A computer implemented derivative instrument management system according to claim 5, wherein said display identifying order options comprises a selectable item which when selected generates an offer to sell a selected credit default swap at a selected price.

8) A computer-implemented derivative instrument management system according to claim 1, wherein said instructions generate a list of currently pending orders associated with a user, and display said currently pending orders for said user.

9) A computer implemented derivative instrument management system according to claim 8, wherein said instructions implement functionality such that when said user positions a position indicator over a price of a pending order, said instructions generate a display displaying selectable actions, one of said selectable actions allowing a user to cancel a pending order.

10) A computer implemented derivative instrument management system according to claim 8, wherein said instructions implement functionality such that when said user positions a position indicator over a price of a pending order, said instructions generate a display displaying selectable actions, said selectable actions allowing a user to aggress a pending order.

11) A computer implemented derivative instrument management process, comprising the steps of:
Receiving at a derivative management platform a request from a user to place an order to either buy or sell a credit default swap,
Generating for said user a display identifying potential credit default swaps, said potential credit default swaps having an open date, a days remaining characterization, and a standard notional amount associated therewith;
Generating a display identifying current offer prices and bid prices associated with said potential credit default swaps;
Receiving from said user through a computer interface an identification of an proposed order for a credit default swap desired to be placed by said user to purchase or sell a credit default swap;
Testing said proposed order to determine whether said order complies with price controls;
When said proposed order complies with said price controls, electronically publishing said proposed order to identify potential counterparties for said order.

12) A computer implemented derivative instrument management process according to claim 11, wherein said price controls comprise comparison of an order price with current bids and offers associated with said credit default swap.

13) A computer implemented derivative instrument management process according to claim 11, wherein said price controls test said proposed credit default swap order to determine whether a notional associated with said proposed order complies with notional multiple requirements associated with said potential credit default swap.

14) A computer implemented derivative instrument management process according to claim 11, wherein said display identifying current offer prices and bid prices associated with said potential credit default swaps further comprises information identifying when said credit default swaps associated with said proposed order issued, and the time remaining before expiration of said credit default swap.

15) A computer implemented derivative instrument management process according to claim 11, wherein said display identifying current offer prices and bid prices associated with said credit default swaps further comprises functionality such that when a user places a position indicator over a price associated with potential credit default swap for ordering, said computer implemented derivative instrument management process further generates a display for said user displaying user selectable tasks.

16) A computer implemented derivative instrument management process according to claim 15, wherein said user selectable tasks comprise generating an offer for a potential credit default swap in a standard notional amount at the price over which the position indicator was located.

17) A computer implemented derivative instrument management process according to claim 15, wherein said user selectable tasks comprise generating an order aggress a credit default swap at the price over which the position indicator was located.

18) A computer implemented derivative instrument management process according to claim 17, further comprising the step of presenting a user with a display identifying said user's pending orders.

19) A computer implemented derivative instrument management process according to claim 18, wherein when a user places a position indicator on said display over a price associated with a pending order for a credit default swap, said computer implemented derivative instrument management process further generates a display for said user displaying user selectable tasks.

20) A computer implemented derivative instrument management process according to claim 19, wherein said user selectable tasks comprises cancelling a pending order for a credit default swap.
